(19) United States
(12) Patent Application Publication
(10) Pub. No.: US 2026/0273820 A1
(43) Pub. Date: Sep. 17, 2026

(54) CABLE WITH MOLDED BODY AND METHOD FOR MANUFACTURING CABLE WITH MOLDED BODY

(71) Applicant: Proterial, Ltd., Tokyo (JP)

(72) Inventors: Hiroshi YAMADA, Tokyo (JP); Tomoaki SUZUKI, Tokyo (JP); Junichi KIKUCHI, Tokyo (JP); Koji FUKUDA, Tokyo (JP)

(73) Assignee: Proterial, Ltd., Tokyo (JP)

(21) Appl. No.: 19/538,336

(22) Filed: Feb. 12, 2026

(30) Foreign Application Priority Data
Mar. 13, 2025 (JP) 2025-040185

(51) Int. Cl. B29C 45/26; B29C 45/14

(52) U.S. Cl. CPC B29C 45/2669; B29C 45/1418; B29C 45/14385; B29C 45/14549; B29C 45/14639; B29C 45/14655

(57) ABSTRACT

A cable with molded body includes a conductor wire, a sheath covering the conductor wire, and a molded body made of a resin material and covering an outer circumferential surface of the sheath at a portion in the longitudinal direction, wherein a groove extending in a direction intersecting the longitudinal direction is formed on the outer circumferential surface of the sheath, and the resin material enters and fills the groove.

### CROSS-REFERENCE TO RELATED APPLICATIONS

The present application is based on Japanese patent application No. 2025-040185 filed on Mar. 13, 2025, the entire contents of which are incorporated herein by reference.

### TECHNICAL FIELD

The present invention relates to a cable with molded body in which a molded body is formed so as to cover an outer circumferential surface of a cable at a portion in a longitudinal direction, and a method for manufacturing the same.

### BACKGROUND OF THE INVENTION

For example, an ABS (Anti-lock Brake System) sensor to detect wheel rotational speed is one example of conventional molded body that covers the outer circumferential surface of a longitudinal portion of a cable. In Patent Literature 1, the present applicant has proposed an invention relating to a cable with ABS sensor (a cable with molded body) in which such an ABS sensor is provided at an end of a cable.

The wire harness (the cable with molded body) described in Patent Literature 1 is for use in vehicles such as automobiles and has a cable including plural first electric wires and plural second electric wires, a tube covering the plural second electric wires branched from the plural first electric wires, a waterproof portion to suppress ingress of water into the tube, and a sensor unit constituting an ABS sensor. The tube is a tubular resin member that has a tubular shape and is made of a resin such as urethane. The plural first electric wires are connected to an electric parking brake device, and the plural second electric wires are connected to lead wires of a sensor main body of the sensor unit.

In the sensor unit, the plural second electric wires extending out of the tube and the sensor main body are held by a resin holder. Then, an end portion of the tube, the plural second wires, the sensor main body and the holder are covered with a molded body formed by molding a resin material.

In this configuration, the tube (the tubular resin member) and the molded body can be fused together by heat during molding, thereby suppressing the ingress of water along the outer circumference of the tube into the interior of the molded body. In other words, it has an effect of enhancing the watertightness of the molded body.

Citation List Patent Literature 1: JP2022-030553A

### SUMMARY OF THE INVENTION

To further enhance the watertightness of the molded body in the technique of Patent Literature 1 described in the background of the invention above, the fused portion between the tube (corresponding to the sheath of the present invention) and the molded body needs to be increased in length, which causes a problem in that the size of the molded body increases. In other words, there is still room for improvement in watertightness of the molded body.

Therefore, it is an object of the invention to provide a cable with molded body which can have enhanced watertightness of a molded body, and a manufacturing method thereof.

To solve the above-mentioned problem, the invention provides a cable with molded body, comprising:
a conductor wire;
a sheath covering the conductor wire; and
a molded body comprising a resin material and covering an outer circumferential surface of the sheath at a portion in a longitudinal direction,
wherein a groove extending in a direction intersecting the longitudinal direction is formed on the outer circumferential surface of the sheath, and the resin material enters and fills the groove.

To solve the above-mentioned problem, the invention also provides a method for manufacturing a cable with molded body that comprises a conductor wire, a sheath covering the conductor wire, and a molded body comprising a resin material and covering an outer circumferential surface of the sheath at a portion in a longitudinal direction, the method comprising:
forming a groove on the outer circumferential surface of the sheath, the groove extending in a direction intersecting the longitudinal direction; and
molding the molded body by placing the sheath with the groove formed thereon in a mold and injecting a molten resin into the mold.

### Advantageous Effects of the Invention

According to the present invention, it is possible to provide a cable with molded body that can have enhanced watertightness of a molded body, and a manufacturing method thereof.

### BRIEF DESCRIPTION OF DRAWINGS

FIG. 1 is a configuration diagram illustrating a cable with molded body in the first embodiment of the present invention, and a vehicle wheel bearing device to be combined with the cable with molded body.

FIG. 2A is a perspective view showing an appearance of the cable with molded body.

FIG. 2B is an explanatory diagram illustrating the internal structure of the cable with molded body.

FIG. 3A is a configuration diagram of the cable with molded body, showing a sensor unit of the cable with molded body in a cross-section.

FIG. 3B is a partial enlarged view of FIG. 3A.

FIG. 4A is a perspective view showing a cable before termination process.

FIG. 4B is a perspective view showing the cable after the termination process.

FIG. 4C is a cross-sectional view taken along line A-A in FIG. 4B.

FIG. 5A is an explanatory diagram of a groove forming step, showing upper and lower molds of a transfer mold before sandwiching a sheath.

FIG. 5B is a cross-sectional view taken along line B-B in FIG. 5A.

FIG. 6A is an explanatory diagram of the groove forming step, showing the upper and lower molds of the transfer mold when sandwiching the sheath.

FIG. 6B is a cross-sectional view taken along line C-C in FIG. 6A.

FIGS. 7A to 7C are explanatory diagram illustrating a molding step, wherein FIG. 7A shows an upper mold of a mold, FIG. 7B shows a lower mold of the mold, and FIG. 7C is a cross-sectional view showing the mold taken along line D-D in FIG. 7B.

FIG. 8A is a configuration diagram of the cable with molded body in the second embodiment of the invention, showing the sensor unit partially in a cross-section.

FIG. 8B is a partial enlarged view of FIG. 8A.

FIG. 9 is a perspective view showing an example configuration of a portion of the cable (the cable after the termination process).

FIG. 10 is an enlarged view showing a portion of the sheath at which plural grooves are formed.

FIG. 11A is a configuration diagram of the cable with molded body in the third embodiment of the invention, showing the sensor unit in a cross-section.

FIG. 11B is a partial enlarged view of FIG. 11A.

FIG. 12A is a perspective view showing an example configuration of a portion of the cable (the cable after the termination process).

FIG. 12B is a cross-sectional view taken along line E-E in FIG. 12A.

FIGS. 13A and 13B are explanatory diagrams illustrating the groove forming step as viewed in the longitudinal direction of the cable.

FIGS. 14A and 14B are cross-sectional views when cross-sections taken along lines F-F and G-G in FIGS. 13A and 13B are viewed in a direction perpendicular to the longitudinal direction of the cable.

FIG. 15A is a configuration diagram of the cable with molded body in the fourth embodiment of the invention, showing the sensor unit in a cross-section.

FIG. 15B is a partial enlarged view of FIG. 15A.

FIG. 16A is a perspective view showing an example configuration of a portion of the cable (the cable after the termination process).

FIG. 16B is a cross-sectional view taken along line H-H in FIG. 16A.

FIGS. 17A to 17F are explanatory diagrams illustrating the groove forming step of forming plural grooves on the outer circumferential surface of the sheath by laser processing.

FIG. 18A is a configuration diagram of the cable with molded body in the fifth embodiment of the invention, showing the sensor unit in a cross-section.

FIG. 18B is a partial enlarged view of FIG. 18A.

FIGS. 19A to 19C are explanatory diagram illustrating the molding step in the fifth embodiment, wherein FIG. 19A shows the upper mold of the mold, FIG. 19B shows the lower mold of the mold, and FIG. 19C is a cross-sectional view showing the mold taken along line I-I in FIG. 19B.

### DETAILED DESCRIPTION OF THE INVENTION

Embodiments of the invention will be described below with reference to the appended drawings.

Conventional wire harnesses to be routed in vehicles such as automobiles come in various types, and the required performance differs between wire harnesses routed inside a vehicle and those routed outside the vehicle (e.g., inside a wheel well or inside an engine compartment) which are locations more likely to be exposed to the outside air than the inside of the vehicle.

One example of the latter type of wire harness routed outside the vehicle is, e.g., a cable with molded body such as a cable with ABS sensor (see Patent Literature 1). One of the performance requirements for such a cable with molded body is watertightness of the molded body (suppression (including prevention) of the ingress of water into the molded body).

The cable with molded body (the wire harness) described in Patent Literature 1 is characterized in that the tubular resin member (the tube) and the molded body are fused together and this fusion suppresses the ingress of water into the molded body.

However, the cable with molded body (the wire harness) described in Patent Literature 1 has the following problems.

When a tube, which is a tubular resin member, is pulled strongly for some reason, the fused portion between the tubular resin member (the tube) and the molded body is broken, resulting in the ingress of water into the molded body. One method of not allowing such ingress of water could be to increase the length of the fused portion between the tubular resin member (the tube) and the molded body. However, adopting this method creates a new problem, which is an increase in the size of the molded body. When the size of the molded body increases, interference with, e.g., a vehicle suspension system, etc., is more likely to occur, leading to reduced vehicle mountability and routing flexibility.

Therefore, the invention has been made in view of the above-mentioned circumstances, etc., and makes it possible to provide a cable with molded body which can have enhanced watertightness of a molded body, and a manufacturing method thereof. Another object is to provide a cable with molded body which can have enhanced watertightness of a molded body while suppressing an increase in the size of the molded body, and a manufacturing method thereof.

Yet another object is to provide a cable with molded body in which the size of the molded body can be reduced, and a manufacturing method thereof.

The concept of the invention is not limited to the above-described field of vehicles such as automobiles, and may also be applied to other product fields (e.g., the field of robots, etc.).

### First Embodiment

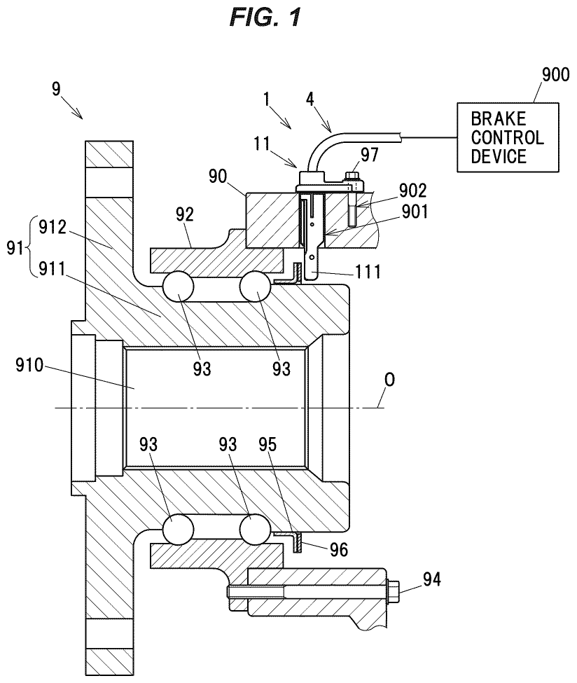

FIG. 1 is a configuration diagram illustrating a cable with molded body 1 in the first embodiment of the invention, and a vehicle wheel bearing device 9 to be combined with the cable with molded body 1.

The cable with molded body 1 is a wire harness used for vehicle such as automobile and having a molded body 3 covering an outer circumferential surface 43a of a cable 4 at a portion in a longitudinal direction, and is also a cable with sensor (a wire harness) having a sensor unit 11 that covers the outer circumferential surface 43a of the cable 4 at a portion in the longitudinal direction. The detection target of the sensor unit 11 is, e.g., a wheel rotational speed.

The wheel bearing device 9 has an inner race 91 integrally having a cylindrical barrel portion 911 and a flange portion 912 to which the wheel is attached, an outer race 92 arranged around the barrel portion 911 of the inner race 91, and plural rolling elements 93 arranged between the barrel portion 911 of the inner race 91 and the outer race 92. A fitting hole 910 into which a drive shaft (not shown) is splined is formed in the center of the barrel portion 911 of the inner race 91 so as to extend along a rotation axis O thereof.

The outer race 92 is fixed by plural bolts 94 to a knuckle 90 which constitutes the suspension system. FIG. 1 shows one of these bolts 94. The knuckle 90 has an attachment hole 901 and a threaded hole 902 which are formed for attachment of the sensor unit 11 of the cable with molded body 1. The attachment hole 901 penetrates knuckle 90 in a direction perpendicular to the rotation axis O of the inner race 91.

An annular magnetic encoder 96 is attached to the barrel portion 911 of the inner race 91 through an attachment member 95. The magnetic encoder 96 has plural N magnetic poles and plural S magnetic poles that are provided alternately along the circumferential direction. The sensor unit 11 of the cable with molded body 1 has a tip portion 111 that protrudes from the attachment hole 901 toward the inner race 91, and the tip portion 111 faces the magnetic encoder 96.

The cable with molded body 1 is connected at one end to a brake control device 900. A magnetic field of the magnetic encoder 96 is detected by the sensor unit 11 provided at one end of the cable with molded body 1, and a detection signal for this magnetic field is transmitted to the brake control device 900 through the cable 4 extending out of this sensor unit. The brake control device 900 controls the braking force of the brakes based on the transmitted detection signal so that the wheel does not lock when the vehicle is under braking.

### Configuration of Cable with Molded Body 1

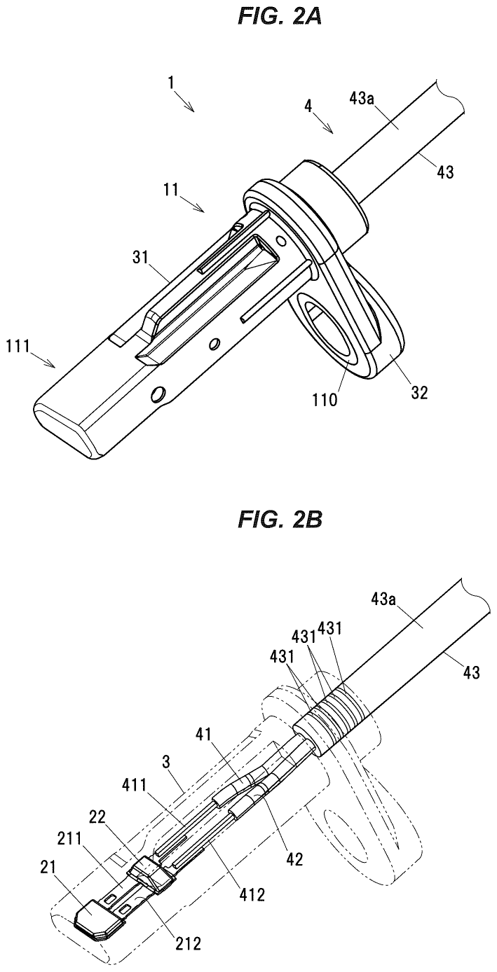

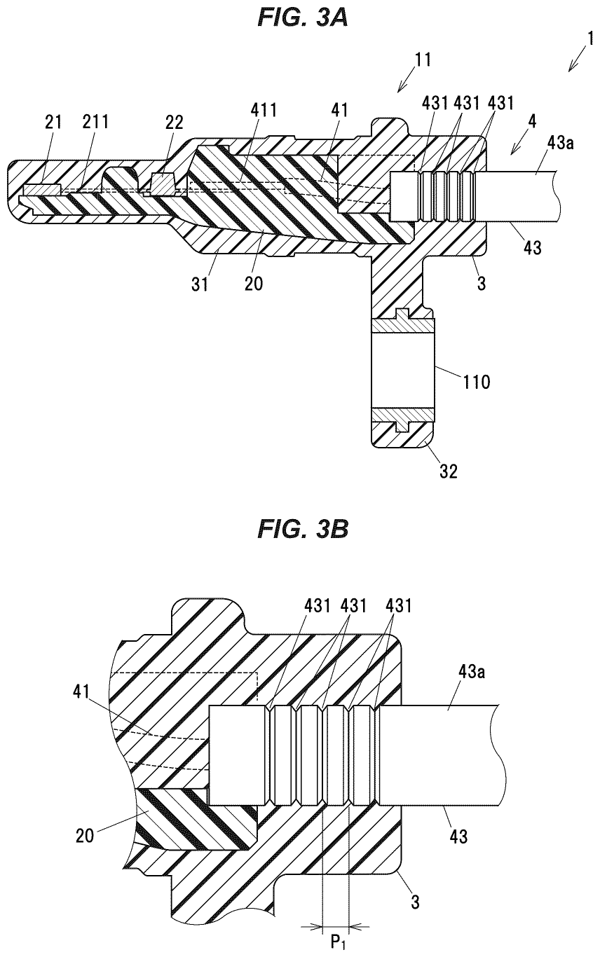

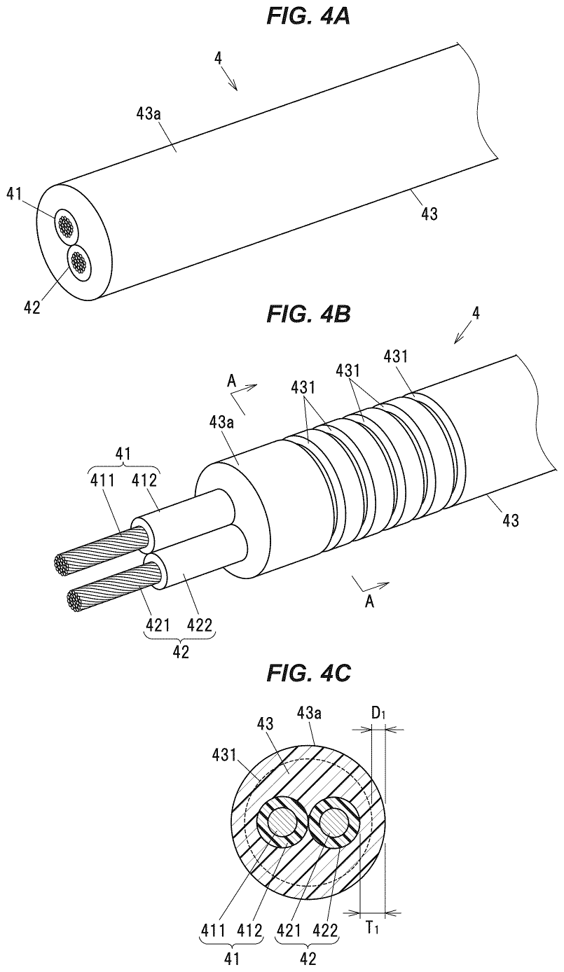

FIG. 2A is a perspective view showing an appearance of the cable with molded body 1. FIG. 2B is an explanatory diagram illustrating the internal structure of the cable with molded body 1. FIG. 3A is a configuration diagram of the cable with molded body 1, showing the sensor unit 11 in a cross-section. FIG. 3B is a partial enlarged view of FIG. 3A. FIG. 4A is a perspective view showing the cable 4 before termination process. FIG. 4B is a perspective view showing the cable 4 after the termination process. FIG. 4C is a cross-sectional view taken along line A-A in FIG. 4C.

The sensor unit 11 includes a sensor element 21 that detects a physical quantity of the detection target, a capacitor 22 as a capacitive element to reduce noise, a resin holder 20 that holds the sensor element 21 and the capacitor 22, the resin molded body 3 formed by molding (injection molding) a resin material, and a metal collar 110 held by the molded body 3. The sensor element 21 and the capacitor 22 are electronic components covered with the molded body 3. The sensor unit 11 is fixed to the knuckle 90 by a bolt 97 (see FIG. 1) inserted through the collar 110 and threaded into the threaded hole 902 of the knuckle 90. In the first embodiment, the molded body 3 is one of the constituent elements of the sensor unit 11.

The sensor element 21 is a magnetic field detection element that detects the direction and strength of a magnetic field as a physical quantity. The sensor element 21 is, e.g., a Hall element in the first embodiment but may be a GMR (Giant Magneto Resistive effect) element, etc. which has higher sensitivity in detecting a magnetic field than the Hall element. The sensor element 21 has two lead wires 211 and 212, and the capacitor 22 is connected between the two lead wires 211 and 212.

The molded body 3 integrally has a shaft portion 31 that covers the holder 20 as well as the sensor element 21 and the capacitor 22, and a flange portion 32 that holds the collar 110. The holder 20 is used to support the sensor element 21 and the capacitor 22 inside a mold during molding of the molded body 3.

When the molded body 3 is molded, the resin holder 20 and the resin molded body 3 are integrated by heat during molding. When the holder 20 and the molded body 3 are integrated, the holder 20 may be considered as a part of the molded body 3, without departing from the gist of the invention.

Taking into consideration the integration, it is desirable that the resin material of the holder 20 and the resin material of the molded body 3 be the same or be similar resin materials. Meanwhile, regarding the colors of the resin material of the holder 20 and the resin material of the molded body 3, it is considered that using the same color is advantageous in that design (a sense of unity between the holder 20 and the molded body 3) and strength are excellent, while using different colors or contrasting colors is advantageous in that it is easy to check the fusion condition at the boundary between the holder 20 and the molded body 3, making it easier to, e.g., set the manufacturing conditions for integration of the holder 20 and the molded body and perform quality control.

The resin material of the molded body 3 used is urethane, but may be, e.g., nylon or PBT (polybutylene terephthalate) which has higher chemical resistance and heat resistance than urethane.

By configuring in this manner, even if the molded body 3 is directly exposed to the outside air and comes into contact with, e.g., calcium chloride used to prevent icing of the road surface, problems such as deterioration of the molded body 3 are unlikely to occur when the molded body 3 is made of nylon or PBT. That is, environmental resistance is enhanced.

As shown in FIGS. 4A to 4C, the cable 4 has two electric wires 41 and 42, and a sheath 43 that covers both the two electric wires 41 and 42. The electric wires 41, 42 are one aspect of the “conductor wire” of the invention, and are insulation-covered wires in each of which a center conductor 411 or 421 composed of a stranded conductor formed by twisting together strands of highly conductive material such as copper is covered with an insulation 412 or 422 made of an insulating resin such as cross-linked polyethylene. Since the sheath 43 is made of, e.g., a resin such as urethane and full extruded, the resin of the sheath 43 also enters valley-shaped gaps between the electric wires 41 and 42.

The first embodiment can be modified as appropriate without departing from the gist of the invention, and the number of electric wires covered with the sheath 43 is not limited to two and may be one, or not less than three. In addition, the center conductors of the electric wires 41 and 42 are not limited to stranded conductors, and may be solid conductors. In addition, as one aspect, the “conductor wire” of the invention may be an electrical wire not covered with the insulation 412 or 422, i.e., a bare wire. In addition, the sheath 43 may have a tubular shape and may be, e.g., a tubular resin member such as a tube made of a resin such as urethane.

FIG. 4A shows one end of the cable 4 which is a portion of the cable 4 in the longitudinal direction and is in a state before the termination process. In the cable 4, the sheath 43 covers the entire longitudinal length of the electric wires 41 and 42. Then, one end of the cable 4 is terminated in such a manner that the electric wires 41 and 42 are exposed by removing an end portion of the sheath 43 and the center conductors 411 and 421 are exposed by further removing end portions of the insulations 412 and 422, as shown in FIG. 4B. In FIG. 4B, the electric wires 41, 42 exposed from the sheath 43 and the center conductors 411, 421 exposed from the insulations 412, 422 are shown shorter than their actual lengths for clarity of explanation.

In the first embodiment, one end of the sheath 43 in the longitudinal direction is covered with the molded body 3. The electric wires 41 and 42 extend out of the one end of the sheath 43 covered with the molded body 3, and the center conductors 411 and 421 are respectively connected to the two lead wires 211 and 212 of the sensor element 21 by, e.g., soldering. In FIGS. 3A and 3B, the electric wire 41 and the lead wire 211 are indicated by dashed lines. During the molding of the molded body 3, the one end of sheath 43 is supported by the holder 20.

Plural grooves 431 extending in a direction intersecting the longitudinal direction of the sheath 43 are formed on the outer circumferential surface 43a of the sheath 43 in the portion covered with the molded body 3. Each groove 431 is formed annularly all the way around the outer circumferential surface 43a along the circumferential direction thereof. The plural grooves 431 are formed in a valley shape with the width narrowing as the depth increases, and the resin material of the molded body 3 enters and fills each of the plural grooves 431. The valley shape of the plural grooves 431 makes it easier for the resin material of the molded body 3 to enter each of the plural grooves 431.

In the first embodiment, five grooves 431 are formed side by side at equal intervals along the longitudinal direction of the sheath 43, and each groove 431 extends in a direction perpendicular to the longitudinal direction of the sheath 43. A pitch P₁ between adjacent grooves 431 is, e.g., not less than 0.5 mm. A depth D₁ of the groove 431 is not less than 30% and not more than 70% of a thickness T₁ of the thinnest portion of the sheath 43, as an example.

By configuring in this manner, even if the sheath 43 and the molded body 3 do not fuse together, the anchor effect by the plural grooves 431 makes it difficult for the sheath 43 to come out of the molded body 3, thereby enhancing the strength of the cable the molded body 1. In addition, even if water enters a slight gap between the outer circumferential surface of the sheath 43 and the molded body 3, the water is blocked by the resin material of the molded body 3 which enters and fills the plural grooves 431, making it possible to prevent the ingress of water toward the sensor element 21. In other words, watertightness of the cable with molded body 1 is enhanced.

### Method for Manufacturing Cable with Molded Body 1

The method for manufacturing the cable with molded body 1 includes a sheath end removal step of removing an end portion of the sheath 43 to expose the electric wires 41 and 42; an insulation removal step of removing end portions of the insulations 412, 422 of the electric wires 41, 42 to expose the center conductors 411, 421; a groove forming step of forming the plural grooves 431 on the outer circumferential surface 43a of the sheath 43 so as to extend in a direction intersecting the longitudinal direction of the sheath 43; a connection step of connecting the center conductors 411, 421 of the electric wires 41, 42 and the capacitor 22 to the two lead wires 211, 212 of the sensor element 21; and a molding step of molding the molded body 3 by injecting a molten resin into a mold after placing the sensor element 21 and the capacitor 22 held by the holder 20 in the mold together with a portion of the cable 4. In the molding step, the sheath 43 on which the plural grooves 431 have been formed on the outer circumferential surface 43a in the groove forming step is placed in the mold so that the resin material of the molded body 3 enters each of the plural grooves 431 on the sheath 43.

In the sheath end removal step, the sheath 43 is sandwiched between a pair of cutting tools perpendicularly to the longitudinal direction to make a cut into the sheath 43, and in this state, the cutting tools and the sheath 43 are moved relative to each other in the longitudinal direction of the sheath 43, thereby removing the sheath 43 on the tip side of the cut portion. In the insulation removal step, end portions of the insulations 412 and 422 are removed using, e.g., a tool such as a wire stripper.

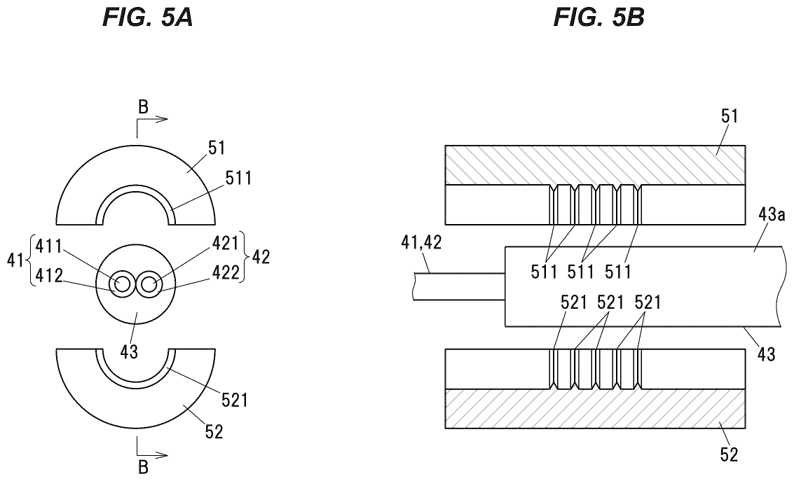

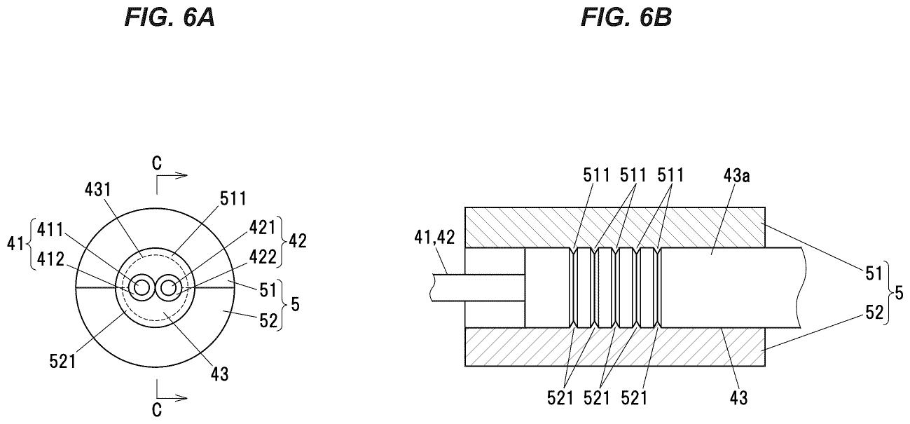

FIGS. 5 and 6 are explanatory diagram illustrating the groove forming step in the first embodiment. In the first embodiment, in the groove forming step, a transfer mold 5 having plural ridges 511, 521 formed thereon is used to form the plural grooves 431 on the sheath 43. The transfer mold 5 has an upper mold 51 and a lower mold 52, and the plural grooves 431 are formed on the outer circumferential surface 43a of the sheath 43 by sandwiching the sheath 43 between the upper mold 51 and the lower mold 52. During transfer molding using the transfer mold 5, the upper mold 51 and the lower mold 52 are heated to a predetermined temperature according to the resin material of the sheath 43.

FIGS. 5A and 5B show the upper mold 51 and the lower mold 52 before sandwiching the sheath 43, and FIGS. 6A and 6B show a state in which the sheath 43 is sandwiched between the upper mold 51 and the lower mold 52. FIGS. 5A and 6A show the state as viewed in the axial direction of the sheath 43. FIG. 5B shows a cross-section of the upper mold 51 and the lower mold 52 taken along line B-B in FIG. 5A, and FIG. 6B shows a cross-section of the upper mold 51 and the lower mold 52 taken along line C-C in FIG. 6A.

As shown in FIGS. 5A and 6A, plural semicircular ridges 511, 521 are provided on the upper mold 51 and the lower mold 52. The ridges 511 of the upper mold 51 and the ridges 521 of the lower mold 52 form rings when the upper and lower molds are closed together. By configuring the transfer mold 5 in this manner, the plural grooves 431 can be simultaneously formed on the outer circumferential surface 43a of the sheath 43, thereby enhancing productivity.

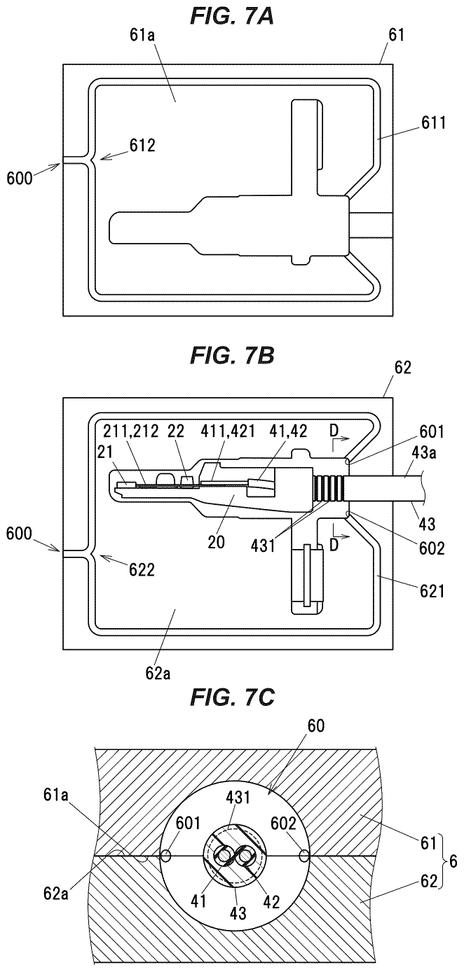

FIGS. 7A to 7C are explanatory diagrams illustrating the molding step in the first embodiment. The molding step is performed using a mold 6 having an upper mold 61 and a lower mold 62. FIG. 7A shows a mating surface 61a of the upper mold 61, and FIG. 7B shows a mating surface 62a of the lower mold 62. FIG. 7C is a cross-sectional view showing the mold 6 takin along line D-D in FIG. 7B.

A cavity 60 of the mold 6 formed by combining the upper mold 61 and the lower mold 62 accommodates the sensor element 21 with the lead wires 211, 212 connected to the center conductors 411, 421 of the electric wires 41, 42, the capacitor 22, the holder 20 holding the sensor element 21 and the capacitor 22, the collar 110, and an end portion of the sheath 43 including a portion on which the plural grooves 431 are formed.

Runner grooves 611 and 621, which form a runner serving as a flow path for molten resin, are respectively formed on the mating surface 61a of the upper mold 61 and the mating surface 62a of the lower mold 62. The molten resin is introduced through an inlet port 600 of the mold 6, branches at branching portions 612, 622 of the runner grooves 611, 621, and is injected into the cavity 60 through two gates 601, 602. At this time, the molten material enters each of the plural grooves 431 of the sheath 43. The molten resin injected into the cavity 60 is cooled and solidified into the molded body 3.

### Effect of the First Embodiment

In the first embodiment described above, the plural grooves 431 are formed on the sheath 43. Therefore, even if the length of the portion of the sheath 43 covered with the molded body 3 is reduced, water is less likely to enter the inside of the molded body 3 along the outer circumference of the sheath 43, thereby enhancing the watertightness to prevent the ingress of water into the molded body 3. In addition, the length of the portion of the sheath 43 covered with the molded body 3 can be reduced, and the molded body 3 can thus be reduced in size.

In other words, it is possible to enhance the watertightness of the molded body 3 while suppressing an increase in the size of the molded body 3. Otherwise, it is possible to reduce the size of the molded body.

### Second Embodiment

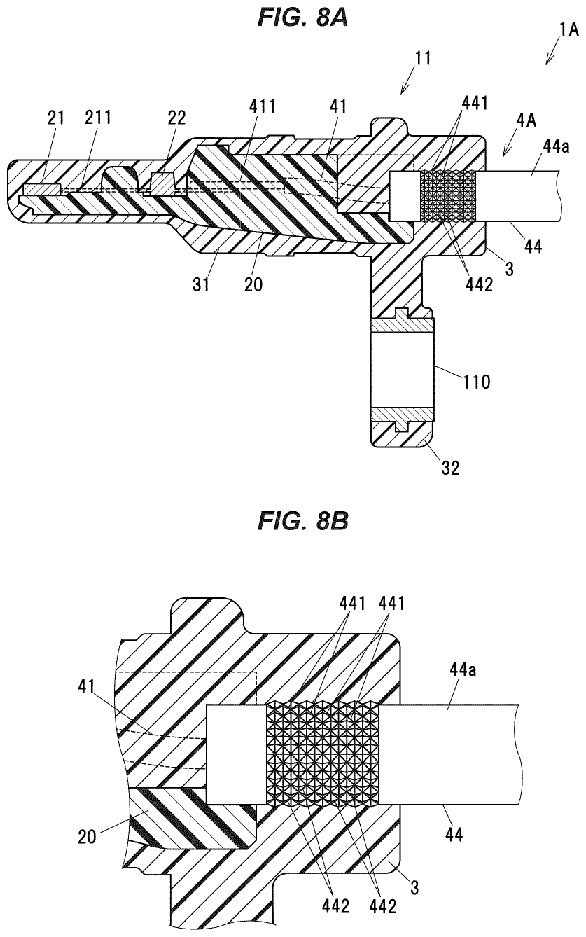

FIG. 8A is a configuration diagram of a cable with molded body 1A in the second embodiment of the invention, showing the sensor unit 11 of the cable with molded body 1A in a cross-section. FIG. 8B is a partial enlarged view of FIG. 8A. The cable with molded body 1A in the second embodiment has the same sensor unit 11 as that of the cable with molded body 1 in the first embodiment, and the center conductors 411, 421 of the electric wires 41, 42 are connected to the lead wires 211, 212 of the sensor element 21. However, plural grooves formed on a sheath 44 covering the electric wires 41, 42 have a different shape from the plural grooves 431 on the sheath 43 in the first embodiment. The electric wires 41, 42 and the sheath 44 constitute a cable 4A in the second embodiment.

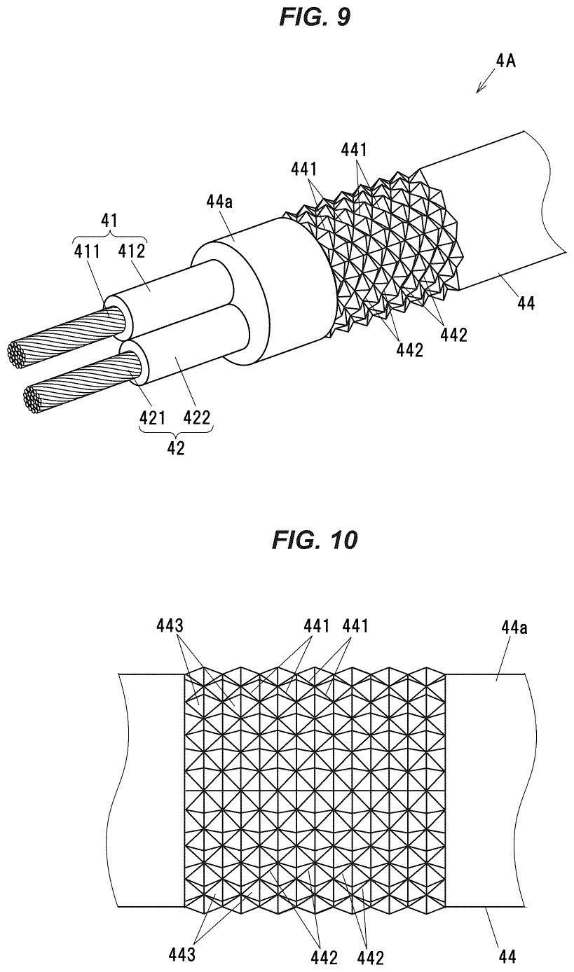

FIG. 9 is a perspective view showing an example configuration of the cable 4A. FIG. 10 is an enlarged view showing a portion of the sheath 44 of the cable 4A where the plural grooves are formed. The plural grooves formed on an outer circumferential surface 44a of the sheath 44 include first inclined grooves 441 inclined toward one side relative to the longitudinal direction of the sheath 44 and second inclined grooves 442 inclined toward the other side relative to the longitudinal direction of the sheath 44, and the first inclined grooves 441 intersect the second inclined grooves 442.

In the second embodiment, plural first inclined grooves 441 and plural second inclined grooves 442 intersect in a lattice manner and form a knurled pattern. A portion surrounded by a pair of first inclined grooves 441 and a pair of second inclined grooves 442 is a quadrangular pyramid-shaped protrusion 443. The plural first inclined grooves 441 and the plural second inclined grooves 442 can be formed by, e.g., the groove forming step using a transfer mold in the same manner as the sheath 43 in the first embodiment. In the molding step, an end portion of the sheath 44, together with the sensor element 21 and the capacitor 22 held by the holder 20 and the collar 110, is placed in the cavity 60 of the mold 6 and is then covered with the molded body 3 formed of the molten resin injected from the inlet port 600 of the mold 6, in the same manner as the first embodiment.

Also in the second embodiment, the molded body 3 can be reduced in size and can have improved watertightness in the same manner as the first embodiment. In addition, since the portion surrounded by a pair of first inclined grooves 441 and a pair of second inclined grooves 442 is a quadrangular pyramid-shaped protrusion 443, the protrusion 443 has a large surface area per unit volume and thus melts easily by heat of the molten resin. This enhances compatibility with the molded body 3, which further improves the watertightness.

### Third Embodiment

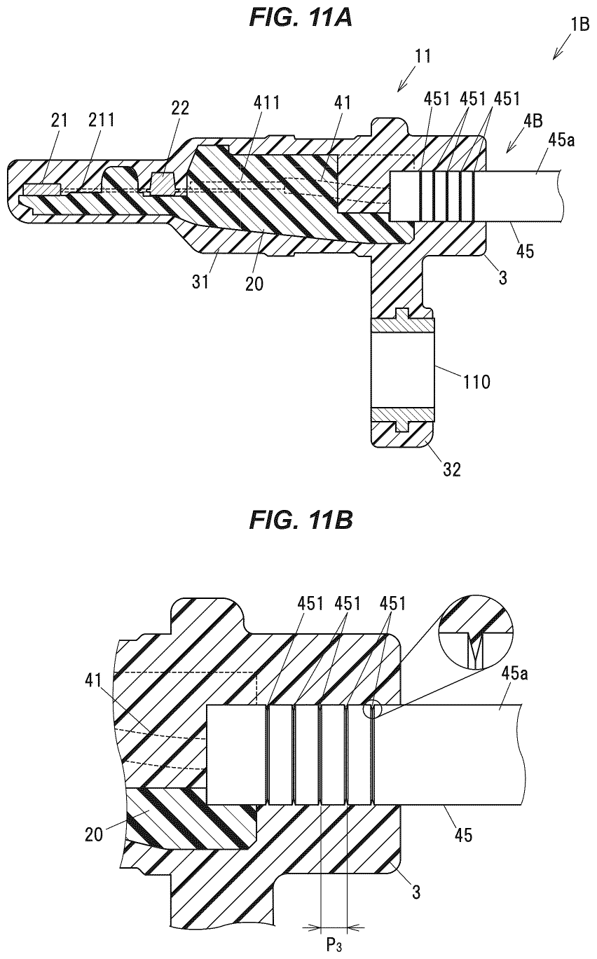

FIG. 11A is a configuration diagram of a cable with molded body 1B in the third embodiment of the invention, showing the sensor unit 11 of the cable with molded body 1B in a cross-section. FIG. 11B is a partial enlarged view of FIG. 11A. The cable with molded body 1B in the third embodiment has the same sensor unit 11 as that of the cable with molded body 1 in the first embodiment, and the center conductors 411, 421 of the electric wires 41, 42 are connected to the lead wires 211, 212 of the sensor element 21. However, plural grooves formed on a sheath 45 covering the electric wires 41, 42 have a different shape from the plural grooves 431 on the sheath 43 in the first embodiment. The electric wires 41, 42 and the sheath 45 constitute a cable 4B in the third embodiment.

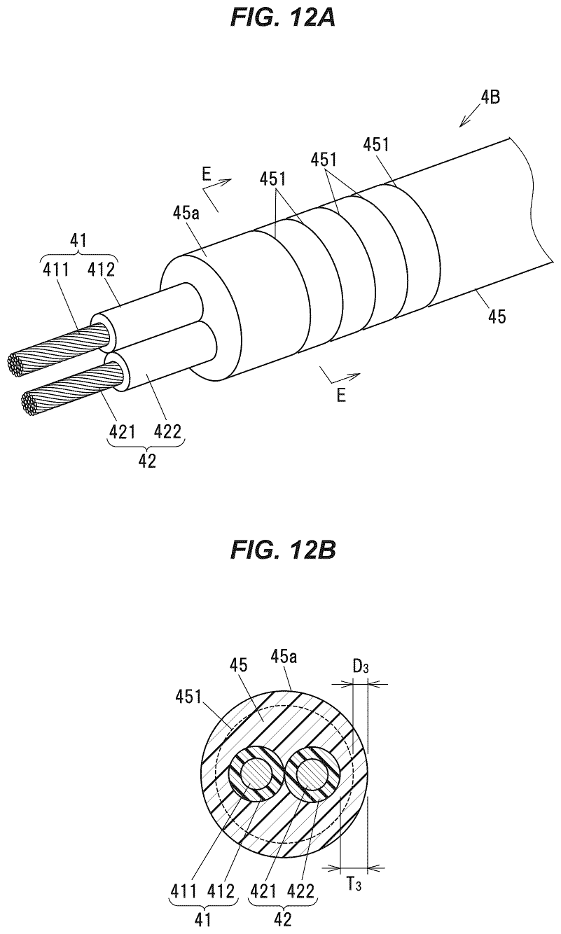

FIG. 12A is a perspective view showing an example configuration of the cable 4B in the third embodiment. FIG. 12B is a cross-sectional view taken along line E-E in FIG. 12A. In the third embodiment, plural grooves 451, which are slits cut into an outer circumferential surface 45a, are formed at one longitudinal end of the sheath 45 covered with the molded body 3. Each groove 451 is formed annularly all the way around the outer circumferential surface 45a of the sheath 45 along the circumferential direction thereof. In addition, each groove 451 extends in a direction perpendicular to the longitudinal direction of the sheath 45.

The resin material of the molded body 3 enters and fills each of the plural grooves 451. In the third embodiment, five grooves 451 are formed side by side at equal intervals along the longitudinal direction of the sheath 45. A pitch P₃ between adjacent grooves 451 is, e.g., not less than 0.5 mm. A depth D₃ of the groove 451 is not less than 30% and not more than 70% of a thickness T₃ of the thinnest portion of the sheath 45, as an example.

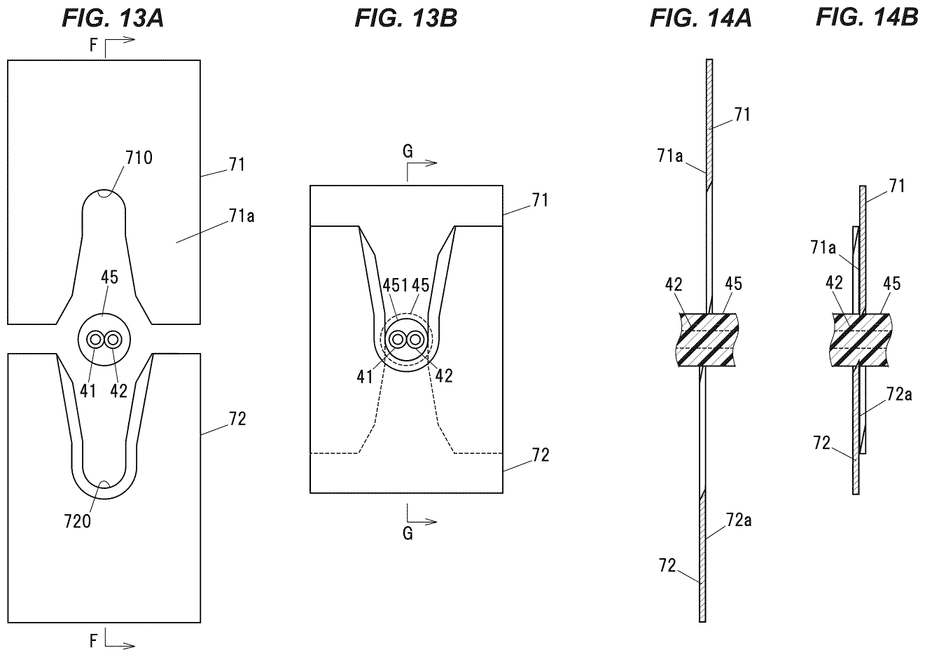

FIGS. 13A, 13B, 14A and 14B are explanatory diagrams illustrating the groove forming step of forming the plural grooves 451 on the outer circumferential surface 45a of the sheath 45. FIGS. 13A and 13B show the state as viewed in the longitudinal direction of the sheath 45. FIGS. 14A and 14B show cross-sections taken along lines F-F and G-G in FIGS. 13A and 13B as viewed in a direction perpendicular to the longitudinal direction of the sheath 45.

The plural grooves 451 are formed using a pair of cutting tools 71 and 72. The cutting tools 71 and 72 are single-edged and are arranged so that flat back surfaces 71a and 72a face each other. The cutting tools 71 and 72 have respectively semicircular arc blade portion 710, 720 formed with a radius of curvature corresponding to the radius of the groove bottom circle of the groove 451, and one annular groove 451 is formed when the cutting tools 71 and 72 are moved relative to each other so as to sandwich the sheath 45. In other words, in the third embodiment, the groove 451 is formed on the outer circumferential surface 45a of the sheath 45 by making a slit with the cutting tools 71 and 72. FIGS. 13A and 14A show a state in which the sheath 45 is positioned between the pair of cutting tools 71, 72. FIGS. 13B and 14B show a state in which the arc blade portions 710 and 720 of the pair of cutting tools 71 and 72 cut into the sheath 45.

In the third embodiment, the groove forming step of forming the plural grooves 451 is performed after the sheath end removal step of removing an end portion of the sheath 45 to expose the electric wires 41 and 42. In the sheath end removal step, the cutting tools 71 and 72, which are also used in the groove forming step, are used to remove an end portion of the sheath 45 but cut into the sheath 45 deeper than in the groove forming step, and in this state, the sheath 45 and the cutting tools 71 and 72 are moved relative to each other in the longitudinal direction of the sheath 45. The sheath 45 on the tip side of the cut portion is thereby removed. At this time, the sheath 45 is torn off at a portion not reached by the cutting tools 71 and 72 (at a portion around the electric wires 41 and 42).

In the groove forming step, the sheath 45 and the cutting tools 71, 72 are moved relative to each other in the longitudinal direction of the sheath 45 at the pitch P₃, thereby forming plural grooves 451 sequentially. Performing the groove forming step after the sheath end removal step can prevent the sheath 45 from being torn off at the portions where the grooves 451 are formed. That is, in case that the sheath end removal step is performed after the groove forming step, there is a risk that the sheath 45 may be torn off at the portions having the plural grooves 451 when the sheath 45 and the cutting tools 71, 72 are moved relative to each other in the state in which the cutting tools 71, 72 cut into the sheath 45 in the sheath end removal step. However, performing the groove forming step after the sheath end removal step can prevent such processing failure from occurring.

Also in the third embodiment, the molded body 3 can be reduced in size and can have improved watertightness in the same manner as the first embodiment. In addition, for example, the sheath end removal step and the groove forming step can be performed by the same equipment without using a transfer mold as in the first and second embodiments, hence, manufacturing costs can be reduced. In this regard, the sheath end removal step may be performed using a cutting tool which is dedicated to the sheath end removal step and has a different shape from the cutting tools 71 and 72 used in the groove forming step. In this case, it is possible to cut into the sheath 45 closer to the electric wires 41, 42 in the sheath end removal step, which reduces an area of a torn-off portion of the sheath 45 and allows the end portion of the sheath 45 to be removed more smoothly.

### Fourth Embodiment

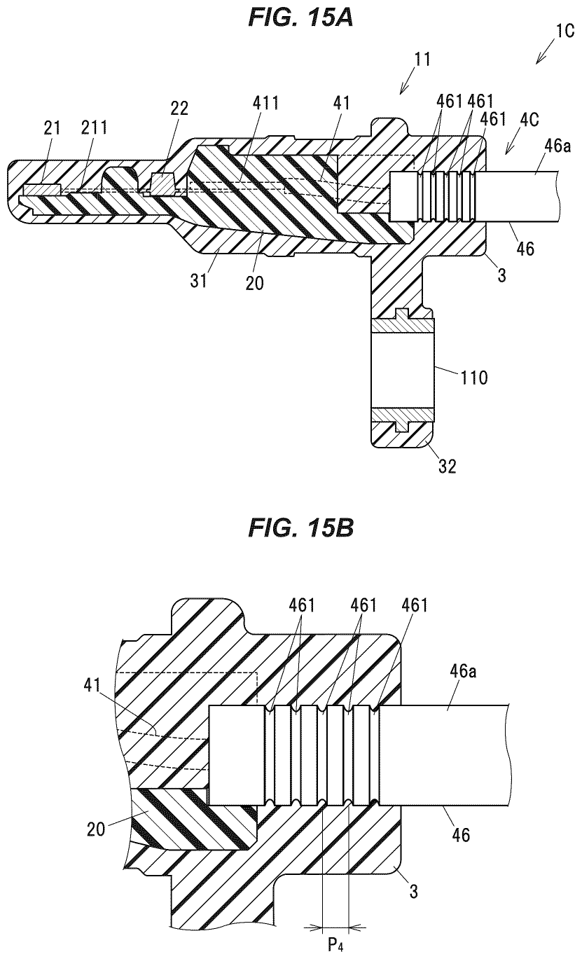

FIG. 15A is a configuration diagram of a cable with molded body 1C in the fourth embodiment of the invention, showing the sensor unit 11 of the cable with molded body 1C in a cross-section. FIG. 15B is a partial enlarged view of FIG. 15A. The cable with molded body 1C in the fourth embodiment has the same sensor unit 11 as that of the cable with molded body 1 in the first embodiment, and the center conductors 411, 421 of the electric wires 41, 42 are connected to the lead wires 211, 212 of the sensor element 21. However, the fourth embodiment differs from the first embodiment in that plural grooves 461 are formed by irradiating a sheath 46 covering the electric wires 41, 42 with laser light. The electric wires 41, 42 and the sheath 46 constitute a cable 4C in the fourth embodiment.

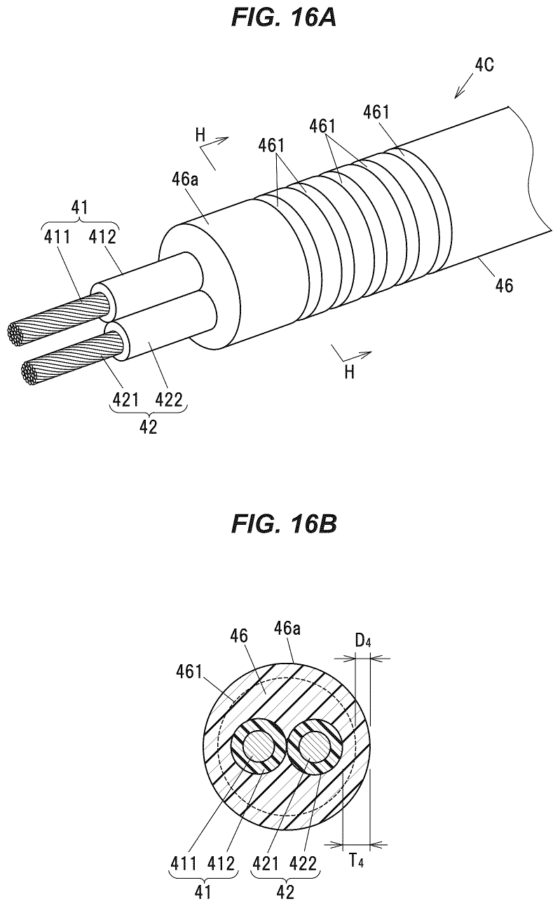

FIG. 16A is a perspective view showing an example configuration of the cable 4C. FIG. 16B is a cross-sectional view taken along line H-H in FIG. 16A. Plural grooves 461 extending in a direction intersecting the longitudinal direction of the sheath 46 are formed on an outer circumferential surface 46a of the sheath 46 in the portion covered with the molded body 3. Each groove 461 is formed annularly all the way around the outer circumferential surface 46a along the circumferential direction thereof, and the resin material of the molded body 3 enters and fills each of the plural grooves 461.

In the fourth embodiment, five grooves 461 are formed side by side at equal intervals along the longitudinal direction of the sheath 46, and each groove 461 extends in a direction perpendicular to the longitudinal direction of the sheath 46. A pitch P₄ between adjacent grooves 461 is, e.g., not less than 0.5 mm. A depth D₄ of the groove 461 is not less than 30% and not more than 70% of a thickness T₄ of the thinnest portion of the sheath 46, as an example.

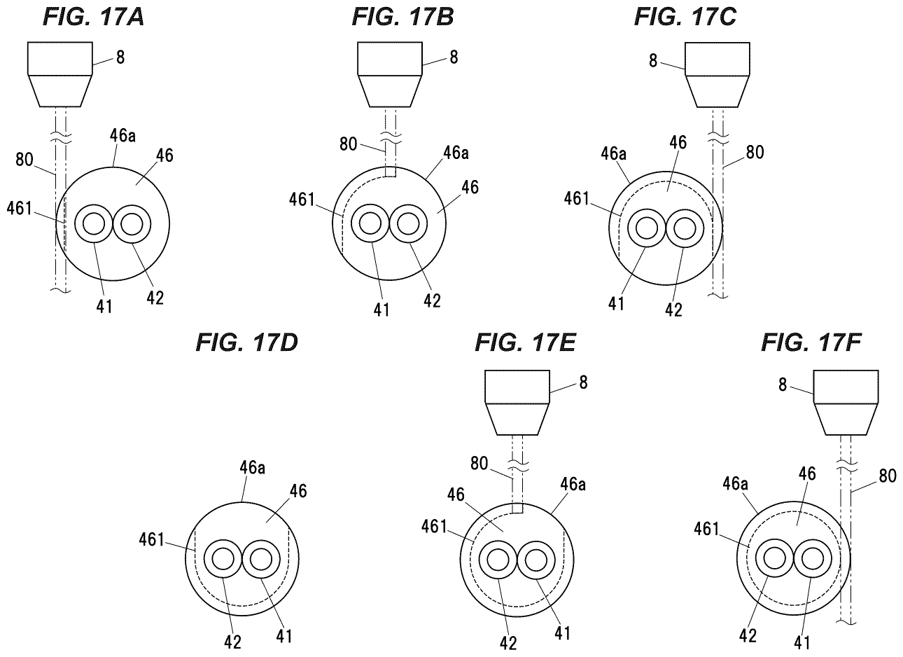

FIGS. 17A to 17F are explanatory diagrams illustrating the groove forming step of forming the plural grooves 461 on the outer circumferential surface 46a of the sheath 46. In the fourth embodiment, in the groove forming step, the plural grooves 461 are formed on the outer circumferential surface 46a of the sheath 46 by laser light 80 emitted from a laser head 8 of a laser beam machining device. The laser beam machining device can adjust the focal distance and intensity of the laser light 80 emitted from the laser head 8.

The groove forming step in the fourth embodiment includes a first half to form the groove 461 in a semicircular (180°) range of the outer circumferential surface 46a of the sheath 46 by irradiation with the laser light 80, and a second half to form the groove 461 in the other semicircular range of the outer circumferential surface 46a of the sheath 46 by irradiation with the laser light 80, and after completing the first half and before performing the second half, the sheath 46 is rotated half a turn relative to the laser head 8.

FIGS. 17A to 17C show the first half, and FIGS. 17D to 17F show the second half. Dashed lines in FIGS. 17A to 17F indicate the bottom of the groove 461 during its formation. In the first half and the second half, the laser beam machining device adjusts the focal distance and intensity of the laser light 80 so that the groove 461 with a substantially constant depth is formed annularly.

FIG. 17A shows state in the initial stage of the first half, and FIG. 17C shows the state in the later stage of the first half. FIG. 17B shows the state in the intermediate stage of the first half. In the first half, the sheath 46 is irradiated with the laser light 80 in a direction perpendicular to the longitudinal direction of the sheath 46, and simultaneously, the laser head 8 is moved relative to the sheath 46 in a direction perpendicular to the longitudinal direction of the sheath 46 and to the emitting direction of the laser light 80.

FIG. 17D shows the state in the initial stage of the second half after rotating the sheath 46 by half a turn. FIG. 17E shows the state in the intermediate stage of the second half, and FIG. 17F shows the state in the later stage of the second half. Also in the second half, the sheath 46 is irradiated with the laser light 80 in a direction perpendicular to the longitudinal direction of the sheath 46, and simultaneously, the laser head 8 is moved relative to the sheath 46 in a direction perpendicular to the longitudinal direction of the sheath 46 and to the emitting direction of the laser light 80, in the same manner as the first half. One annular groove 461 is formed after the second half is completed. In the groove forming step, the first half and the second half are repeated the same number of times as the number of grooves 461 on the sheath 46, thereby forming plural grooves 461.

Also in the fourth embodiment, the molded body 3 can be reduced in size and can have improved watertightness in the same manner as the first embodiment. In addition, since it is possible to form the grooves 461 having a groove width corresponding to the spot diameter of the laser light 80, the groove width of the grooves 461 can be widened to allow more resin material of the molded body 3 to enter the grooves 461, thereby further enhancing the strength and watertightness of the cable with molded body 1C. The desirable range of the groove width of the grooves 461 is not less than 1 mm and not more than 3 mm.

Although the case where the sheath 46 is rotated by half a turn between the first half and the second half of the groove forming step to form the annular grooves 461 on the outer circumferential surface 46a of the sheath 46 has been described in the fourth embodiment, the configuration is not limited thereto. The groove 461 may be formed on the outer circumferential surface 46a of the sheath 46 by irradiating the sheath 46 with the laser light 80 while rotating the sheath 46 at a constant speed about its central axis. In this case, the laser light 80 is emitted perpendicular to the central axis of the sheath 46.

### Fifth Embodiment

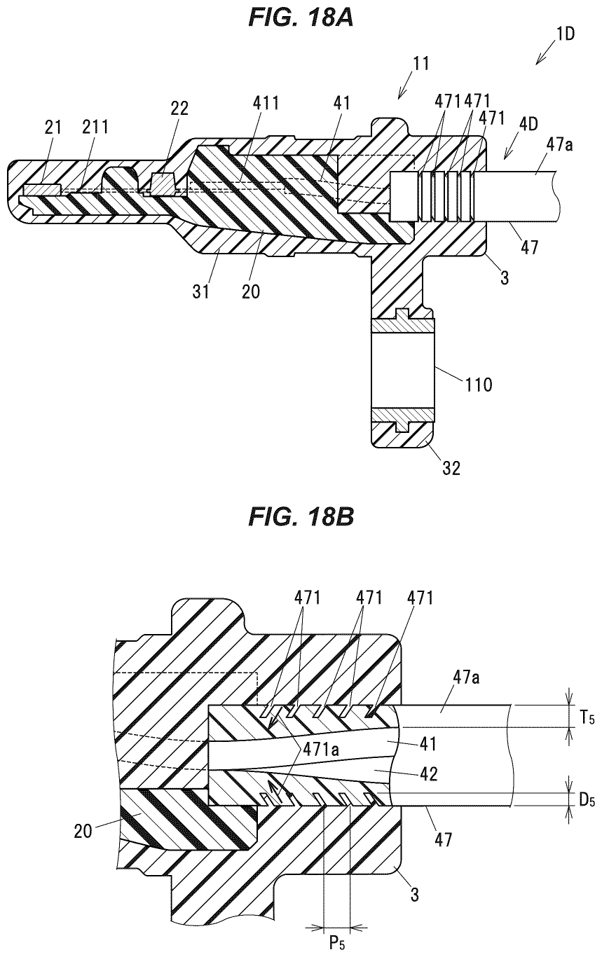

FIG. 18A is a configuration diagram of a cable with molded body 1D in the fifth embodiment of the invention, showing the sensor unit 11 of the cable with molded body 1D in a cross-section. FIG. 18B is an enlarged view showing a portion of FIG. 18A together with the cross-sectional shape of a sheath 47. In the cable with molded body 1D in the fifth embodiment, plural grooves 471 are formed by laser machining at one longitudinal end of the sheath 47 covering the electric wires 41, 42, and the resin material of the molded body 3 enters and fills each of the plural grooves 471, in the same manner as the cable with molded body 1C in the fourth embodiment. However, in the fifth embodiment, the plural grooves 471 are formed in a conical shape inclined with respect to the radial direction of the sheath 47 so that the grooves 471 get closer to the sensor element 21 as the depth increases. The shape of the opening of each groove 471 when viewing an outer circumferential surface 47a of the sheath 47 in the radial direction of the sheath 47 is an annular shape which extends all the way around the outer circumferential surface 47a along the circumferential direction thereof. The electric wires 41, 42 and the sheath 47 constitute a cable 4Din the fifth embodiment.

The extending direction of the plural grooves 471 indicated by arrows 471a in FIG. 18B, i.e., the depth direction of the plural grooves 471, is along a direction in which the resin material flows at the end of the sheath 47 when the molded body 3 is formed. In this regard, the flow direction of the resin material during the formation of the molded body 3 can be confirmed, e.g., by flow marks (flow patterns) or weld lines (weld seams) occurred on the molded body 3, or the position of the injection mark indicating the position where the molten resin was injected. A pitch P₅ between adjacent grooves 471 is, e.g., not less than 0.5 mm. A depth D₅ of the groove 471 in the radial direction of the sheath 47 is not less than 30% and not more than 70% of a thickness T₅ of the thinnest portion of the sheath 47, as an example. Each groove 471 can be formed, e.g., by irradiating the sheath 47 with laser light in a direction inclined with respect to the longitudinal direction of the sheath 47 while rotating the sheath 47 about its central axis.

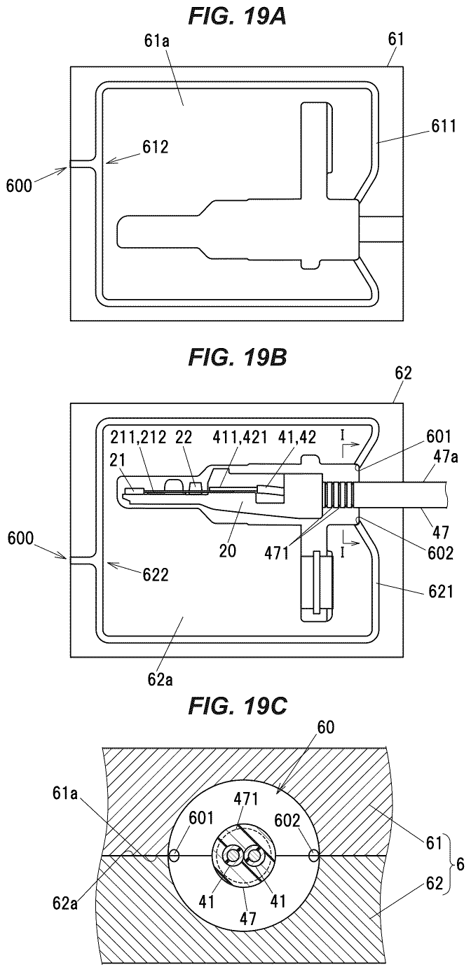

FIGS. 19A to 19C are explanatory diagram illustrating the molding step in the fifth embodiment. FIG. 19A shows the upper mold 61 of the mold 6, and FIG. 19B shows the lower mold 62 of the mold 6. FIG. 19C is a cross-sectional view showing the mold 6 taken along line I-I in FIG. 19B.

The mold 6 shown in FIGS. 19A to 19C is configured in the same manner as that described in the first embodiment and has the upper mold 61 and the lower mold 62, and the runner grooves 611 and 621, which form a runner serving as a flow path for molten resin, are respectively formed on the mating surface 61a of the upper mold 61 and the mating surface 62a of the lower mold 62. The molten resin is introduced through the inlet port 600 of the mold 6, branches at the branching portions 612, 622 of the runner grooves 611, 621, and is injected into the cavity 60 through the two gates 601, 602.

The injection direction of the molten resin from the two gates 601 and 602 is a direction toward the sheath 47 and is also a direction along the extending direction of the plural grooves 471 on the sheath 47 placed in the mold 6. By configuring the mold 6 in this manner, the resin material of the molded body 3 can more easily enter each of the plural grooves 471.

Also in the fifth embodiment, the molded body 3 can be reduced in size and can have improved watertightness in the same manner as the first embodiment. In addition, since the extending direction of the plural grooves 471 when viewed in a cross-section of the sheath 47 taken along the longitudinal direction of the sheath 47 is along the flow direction of the resin material during formation of the molded body 3 and the molten resin is injected into the mold 6 along the extending direction of the plural grooves 471 in the molding step, the resin material of the molded body 3 can easily enter the plural grooves 471, thereby further enhancing the strength and watertightness of the cable with molded body 1D.

### SUMMARY OF THE EMBODIMENTS

Technical ideas understood from the embodiments will be described below citing the reference signs, etc. used for the embodiments. However, each reference sign described below is not intended to limit the constituent elements in the claims to the members, etc., specifically described in the embodiments.

According to the first feature, a cable with molded body 1, 1A-1D comprises: a conductor wire (electric wires 41, 42); a sheath 43-47 covering the conductor wire 41, 42; and a molded body 3 comprising a resin material and covering an outer circumferential surface 43a, 44a, 45a, 46a, 47a of the sheath 43-47 at a portion in a longitudinal direction, wherein a groove 431, 441, 442, 451, 461, 471 extending in a direction intersecting the longitudinal direction is formed on the outer circumferential surface 43a, 44a, 45a, 46a, 47a of the sheath 43-47, and the resin material enters and fills the groove 431, 441, 442, 451, 461, 471.

According to the second feature, in the cable with molded body 1, 1A-1D as described in the first feature, the groove 431, 441, 442, 451, 461, 471 is formed annularly all the way around the outer circumferential surface 43a, 44a, 45a, 46a, 47a.

According to the third feature, in the cable with molded body 1 as described in the first or second feature, the groove 431 is formed in a valley shape with a width narrowing as the depth increases.

According to the fourth feature, in the cable with molded body 1B as described in the first or second feature, the groove 451 comprises a slit formed by cutting in from the outer circumferential surface 45a.

According to the fifth feature, in the cable with molded body 1A as described in the first feature, the groove 441, 442 comprises a first inclined groove 441 inclined toward one side relative to the longitudinal direction and a second inclined groove 442 inclined toward the other side relative to the longitudinal direction, and the first inclined groove 441 and the second inclined groove 442 intersect with each other.

According to the sixth feature, in the cable with molded body 1D as described in the first feature, an extending direction of the groove 471 in a cross-section of the sheath 47 taken along the longitudinal direction is along a direction in which a resin material flows during formation of the molded body 3.

According to the seventh feature, a method for manufacturing a cable with molded body 1, 1A-1D that comprises a conductor wire 41, 42, a sheath 43-47 covering the conductor wire 41, 42, and a molded body 3 comprising a resin material and covering an outer circumferential surface 43a, 44a, 45a, 46a, 47a of the sheath 43-47 at a portion in a longitudinal direction, the method comprising: forming a groove 431, 441, 442, 451, 461, 471 on the outer circumferential surface 43a, 44a, 45a, 46a, 47a of the sheath 43-47, the groove extending in a direction intersecting the longitudinal direction; and molding the molded body 3 by placing the sheath 43-47 with the groove 431, 441, 442, 451, 461, 471 formed thereon in a mold 6 and injecting a molten resin into the mold 6.

According to the eighth feature, in the method for manufacturing a cable with molded body 1 as described in the seventh feature, in the forming the groove, the groove 431 is formed using a transfer mold 5 comprising a ridge 511, 521.

According to the nineth feature, in the method for manufacturing a cable with molded body 1B as described in the seventh feature, in the forming the groove, the groove 451 is formed by making a slit with a cutting tool 71, 72.

According to the tenth feature, in the method for manufacturing a cable with molded body 1C as described in the seventh feature, in the forming the groove, the groove 461 is formed by irradiating the sheath 46 with laser light 80.

According to the eleventh feature, in the method for manufacturing a cable with molded body 1D as described in the seventh feature, an extending direction of the groove 471 in a cross-section of the sheath 47 taken along the longitudinal direction is inclined relative to the longitudinal direction, and in the molding, the molten resin is injected into the mold 6 along the direction of the groove 471.

Although the embodiments of the invention have been described, the invention according to claims is not to be limited to the embodiments described above. Further, please note that not all combinations of the features described in the embodiments are necessary to solve the problem of the invention. In addition, the invention can be appropriately modified and implemented without departing from the gist thereof and, e.g., the following modifications can be implemented.

Although the case where the cables with molded body 1 to 1D have the sensor unit 11 to detect wheel rotational speed has been described in each of the above embodiments, the present is not limited thereto and can be applied to various products in which the outer circumferential surface of a portion of a sheath is covered with a molded body.

In addition, although the case where the plural grooves 431, 441, 451, 461, and 471 are formed on the sheaths 43 to 47 has been described in each of the above embodiments, the number of grooves formed on the sheath of the invention is not limited to more than one, and may be one.

1. A cable with molded body, comprising:
a conductor wire;
a sheath covering the conductor wire; and
a molded body comprising a resin material and covering an outer circumferential surface of the sheath at a portion in a longitudinal direction,
wherein a groove extending in a direction intersecting the longitudinal direction is formed on the outer circumferential surface of the sheath, and the resin material enters and fills the groove.

2. The cable with molded body according to claim 1, wherein the groove is formed annularly all the way around the outer circumferential surface.

3. The cable with molded body according to claim 1, wherein the groove is formed in a valley shape with a width narrowing as a depth increases.

4. The cable with molded body according to claim 1, wherein the groove comprises a slit formed by cutting in from the outer circumferential surface.

5. The cable with molded body according to claim 1, wherein the groove comprises a first inclined groove inclined toward one side relative to the longitudinal direction and a second inclined groove inclined toward an other side relative to the longitudinal direction, and the first inclined groove and the second inclined groove intersect with each other.

6. The cable with molded body according to claim 1, wherein an extending direction of the groove in a cross-section of the sheath taken along the longitudinal direction is along a direction in which the resin material flows during formation of the molded body.

7. A method for manufacturing a cable with molded body that comprises a conductor wire, a sheath covering the conductor wire, and a molded body comprising a resin material and covering an outer circumferential surface of the sheath at a portion in a longitudinal direction, the method comprising:
forming a groove on the outer circumferential surface of the sheath, the groove extending in a direction intersecting the longitudinal direction; and
molding the molded body by placing the sheath with the groove formed thereon in a mold and injecting a molten resin into the mold.

8. The method according to claim 7, wherein in the forming the groove, the groove is formed using a transfer mold comprising a ridge.

9. The method according to claim 7, wherein in the forming the groove, the groove is formed by making a slit with a cutting tool.

10. The method according to claim 7, wherein in the forming the groove, the groove is formed by irradiating the sheath with laser light.

11. The method according to claim 7, wherein an extending direction of the groove in a cross-section of the sheath taken along the longitudinal direction is inclined relative to the longitudinal direction, and wherein in the molding, the molten resin is injected into the mold along the extending direction.
